(19) United States
(12) Patent Application Publication
(10) Pub. No.: US 2015/0204597 A1
(43) Pub. Date: Jul. 23, 2015

(54) COOLING METHOD

(71) Applicants: SNECMA, Paris (FR); CENTRE NATIONAL D'ETUDES SPATIALES CNES, Paris (FR)

(72) Inventor: Yvan Le Goffic, Saint-Marcel (FR)

(73) Assignees: SNECMA, Paris (FR); CENTRE NATIONAL D'ETUDES SPATIALES CNES, Paris (FR)

(21) Appl. No.: 14/420,947

(22) PCT Filed: Aug. 14, 2013
(86) PCT No.: PCT/FR2013/051940

§ 371 Date: Feb. 11, 2015

(30) Foreign Application Priority Data
Aug. 22, 2012 (FR) 1257932

(51) Int. Cl. F25D 3/10; F04D 29/58; F02K 9/46

(52) U.S. Cl. CPC F25D 3/10; F02K 9/46; F04D 29/586

(57) ABSTRACT

A cooling method for cooling a device connected to a cryogenic tank via a main admission duct for feeding the device with cryogenic fluid once the device is cooled. In contrast, during cooling, a cryogenic fluid is introduced into the device via a cooling admission duct that is different from the main admission duct and that presents a flow section that is narrower than the flow section of the main admission duct.

### BACKGROUND OF THE INVENTION

The present invention relates to the field of cryogenic techniques, and in particular to a method of cooling a device connected to a cryogenic tank via a main admission duct for feeding the device with cryogenic fluid once the device is cooled.

In the field of cryogenic techniques, it is often necessary to cool various devices, i.e. to bring their temperature down gradually from ambient temperature to the low operating temperatures of the cryogenic field, in order to avoid thermal shocks. Among devices that normally require such cooling, mention may be made in particular of cryogenic pumps, and more particularly of the turbopumps of rocket engines using cryogenic liquid propellants.

A device is typically cooled by gradually introducing a cryogenic fluid in controlled manner into the device to be cooled. In the prior art, the cryogenic fluid is introduced into the device via the same main admission duct as is used for feeding the device with cryogenic fluid once the device is cooled.

Nevertheless, cooling by introducing the cryogenic fluid via the main admission duct presents certain drawbacks. Since the main admission duct is designed primarily for a flow rate of cryogenic fluid that is significantly greater than that which is introduced into the device for cooling it, and therefore has a flow section that is relatively large, using it for introducing the cryogenic fluid that serves to perform cooling leads in particular to this cryogenic fluid being heated to a large extent before it is introduced into the device. This drawback is made worse when cooling a device, such as a pump, that has a main discharge duct with a flow section that is narrower than the admission flow section. Since the cryogenic fluid leaving the device that is being cooled is itself heated by the masses to be cooled and by heat flow from the outside, the cryogenic fluid leaving the device during cooling is normally gaseous, at least in part. It is therefore important to limit head losses downstream from the device to be cooled, in order to avoid thermally blocking the flow of cryogenic fluid during cooling. Unfortunately, discharging the cryogenic fluid via a main discharge duct that is narrower than the admission duct increases head losses downstream from the device to be cooled, thereby making such discharge significantly more constraining.

### OBJECT AND SUMMARY OF THE INVENTION

The present invention seeks to remedy those drawbacks. In particular, it seeks to propose a cooling method that can be performed more simply.

In at least one implementation of the invention, this object is achieved by the fact that during cooling the cryogenic fluid is introduced into the device to be cooled via a cooling admission duct that is different from the main admission duct for feeding the device with cryogenic fluid once the device is cooled and that presents a flow section that is narrower than the flow section of the main admission duct.

Thus, because of the narrower flow section, the heating of the cryogenic fluid upstream from the device to be cooled is limited. In addition, it is easier to make this cooling admission duct capable of withstanding high pressures so as to simplify performing the cooling method since its narrower section provides a greater margin for accommodating the inlet pressures of the cryogenic fluid into this duct.

Said device may in particular be a pump, e.g. such as a propellant pump for a rocket engine, and more particularly a turbopump. Since the admission ducts of pumps are normally larger and less good at withstanding high pressures than are their discharge ducts, cooling them becomes particularly difficult because of the risk of thermal blockage and of head losses downstream from the pump.

In order to avoid using additional sources of cryogenic fluid, the cryogenic fluid introduced into the device via the cooling admission duct during cooling may also come from said cryogenic tank. In particular, in a first alternative enabling the cryogenic fluid circuit to be simplified and avoiding wasting the cryogenic fluid contained in the tank, the cryogenic fluid may be pumped from the tank to said device via the cooling admission duct, and may return from the device to the tank via said main admission duct in a direction opposite to the normal flow direction of the cryogenic fluid once the device is cooled. Since the main admission duct is of greater section than the cooling admission duct, this reversal of the flow direction during cooling thus largely avoids head losses downstream from the device in the reverse flow direction of the cryogenic fluid during cooling. Nevertheless, in particular in order to avoid any need to pump the fluid during cooling, the main admission duct may alternatively remain closed and the cryogenic fluid that is introduced into the device from the cryogenic tank may then be expelled via a purge line. Thus, the internal pressure inside the tank can suffice to drive the flow.

The cryogenic fluid introduced into the device via the cooling admission duct may nevertheless alternatively come from a source other than the cryogenic tank that feeds the cryogenic device with cryogenic fluid via said main admission duct once the device has been cooled. Particularly, but not exclusively, under such circumstances, the cooling admission duct may be a main discharge duct for the cryogenic fluid once the device is cooled. The cryogenic fluid may then be introduced into said main discharge duct via a purge line during cooling.

### BRIEF DESCRIPTION OF THE DRAWINGS

The invention can be better understood and its advantages appear better on reading the following detailed description of three embodiments given as non-limiting examples. The description refers to the accompanying drawings, in which:

FIG. 1 is a diagram showing the flow of a cryogenic fluid driven by a turbopump in a circuit for feeding a rocket engine with cryogenic propellant;

FIG. 2 is a diagram showing the flow of the cryogenic fluid in the same circuit while the turbopump is being cooled in a first implementation;

FIG. 3 is a diagram showing the flow of cryogenic fluid in a similar circuit while cooling the turbopump in a second implementation; and

FIG. 4 is a diagram showing the flow of cryogenic fluid in another similar circuit while cooling the turbopump in a third implementation.

### DETAILED DESCRIPTION OF THE INVENTION

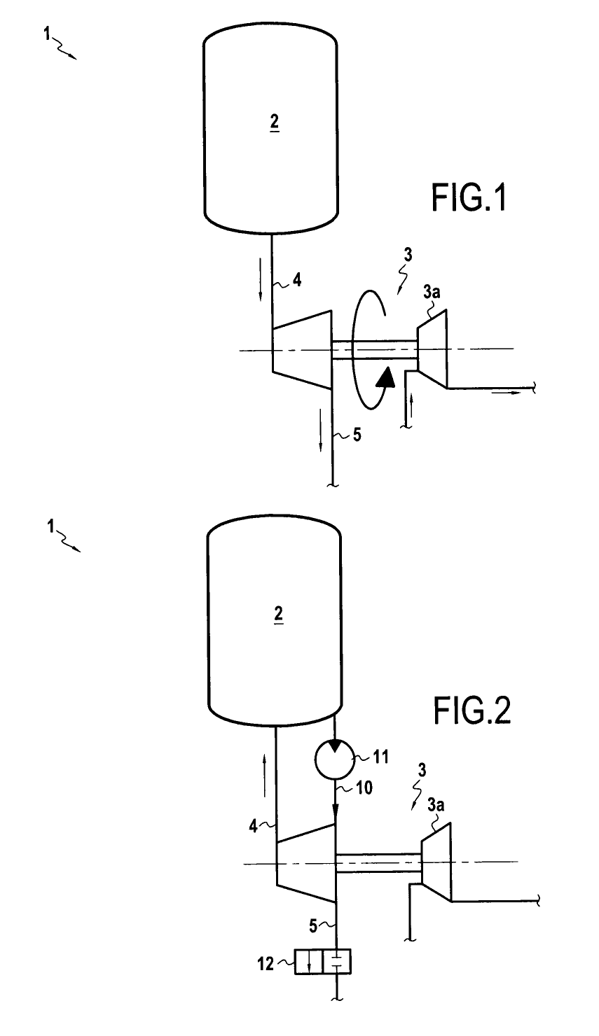

FIG. 1 shows a portion of a circuit 1 for feeding a rocket engine (not shown) with at least one propellant. The circuit 1 comprises a tank 2 containing said propellant in the form of a cryogenic fluid, together with a turbopump 3 for propelling the propellant through the circuit 1 from the tank 2 to at least one combustion chamber of the rocket engine. In the implementation shown, the propellant may be liquid hydrogen, for example. A main duct 4 for admitting cryogenic fluid into the turbopump 3 connects the turbopump to the tank 2. A main duct 5 for discharging the cryogenic fluid from the turbopump 3 connects the turbopump to the combustion chamber of the rocket engine. When the rocket engine is ignited, the expansion of gas in the turbine 3a of the turbopump 3 actuates the turbopump to pump the cryogenic fluid from the tank to the turbopump. This gas may come from a gas generator, as in the feed system for the Vulcain® rocket engine, or else it may be one of the cryogenic propellants, after being heated and vaporized in a circuit for cooling the rocket engine (expander cycle), as in the feed system for the Vinci® rocket engine. The propellant thus flows from the tank 2 successively along said main admission duct 4, through the turbopump 3, and along said main discharge duct 5 to the rocket engine.

Nevertheless, before igniting the rocket engine and in order to avoid a thermal shock as a result of a sudden arrival of cryogenic fluid, it is normally necessary to cool down progressively certain sensitive elements of the circuit 1, and in particular the turbopump 3, by introducing a small flow of cryogenic fluid. FIG. 2 shows the flow of this cryogenic fluid during a period of cooling in a first implementation. In this implementation, an admission duct 10 for cooling and having a flow section that is narrower than that of the main admission duct 4, connects the tank 2 to the turbopump 3 in parallel with the main admission duct 4. A pump 11 is installed in the cooling admission duct 10 and a valve 12 is installed in the main discharge duct 5. While cooling in the manner shown in FIG. 2, the valve 12 remains closed and a small flow of cryogenic fluid is pumped by the pump 11 to the turbopump 3, which is stopped. This cryogenic fluid flows through the turbopump 3 and into the main admission duct 4 in a direction opposite to the normal flow direction once the device is cooled, as shown in FIG. 1, so as to return to the tank 2. Thus, the turbopump 3 and the main admission duct 4 are cooled using the same cryogenic fluid from the tank 2. Nevertheless, most of this cryogenic fluid is recovered even though it has been heated by the masses it has cooled, and it can still be used subsequently for feeding the rocket engine. The reverse flow direction of the cryogenic fluid during cooling from a narrower cooling admission duct 10 to a larger main admission duct 4 serves to avoid thermal blockages and makes it easier to perform cooling.

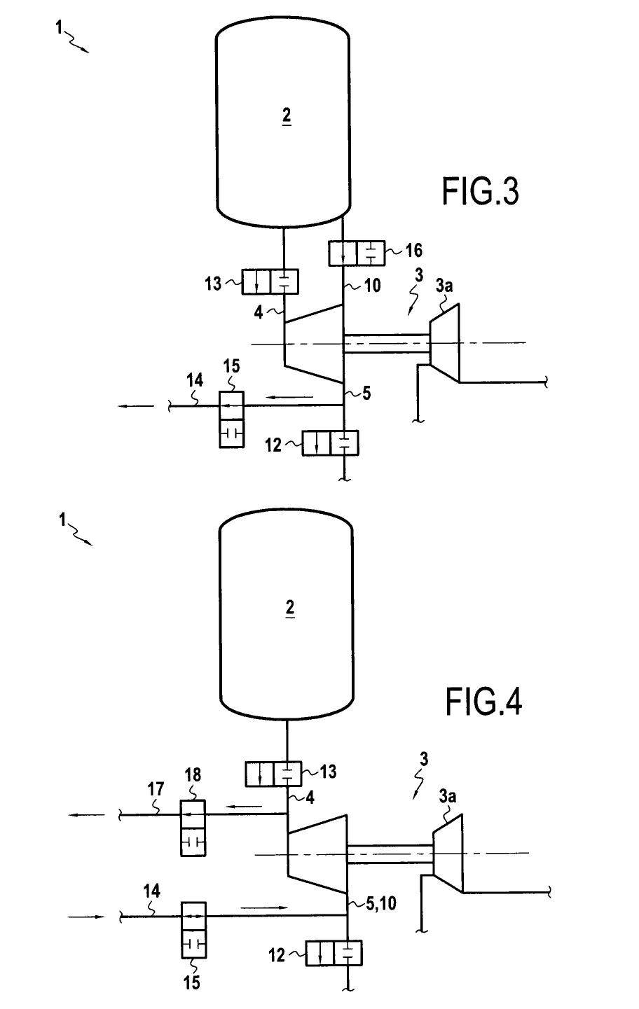

An alternative implementation of this cooling method is nevertheless shown in FIG. 3. In this implementation, the main admission duct 4 has a valve 13 and the main discharge duct 5 is connected to a purge line 14 via a valve 15 situated upstream from its valve 12. In contrast, the cooling admission circuit 10 does not have a pump, but only a valve 16. In order to cool the turbopump 3, the valves 15 and 16 are opened, while the valve 13 of the main admission duct 4 and the valve 12 of the main discharge duct 5 remain closed so as to enable a small flow of cryogenic fluid to flow from the tank 2 under drive from the pressure inside the tank 2 through the cooling admission duct 10, the turbopump 3 while stopped, the main discharge duct 5, and the purge line 14 leading to the outside. Thus, in this implementation, the cryogenic fluid used for cooling is expelled to the outside and therefore cannot normally be reused subsequently for feeding the rocket engine. In contrast, this implementation can be performed without needing additional pump means in the circuit 1, since the pressure difference between the inside and the outside of the tank 2 suffices to drive the flow of cryogenic fluid for cooling purposes.

Another alternative implementation of this cooling method is shown in FIG. 4. In this implementation, the cryogenic fluid used for cooling does not come from the tank 2, but from an external source connected to the main discharge duct 5 via the purge line 14. Thus, in this implementation, the cooling admission duct 10 does not connect the turbopump 3 to the tank 2 in parallel with the main admission duct 4, but is formed by the main discharge duct 5. In this implementation, the main admission duct 4 is connected between the valve 13 and the turbopump 3 to another purge line 17 via a valve 18. When performing the cooling method in this implementation, the valves 12 and 13 remain closed, while the purge line 14 is connected to an external source of cryogenic fluid and the valves 15 and 18 are opened in order to allow a small flow of cryogenic fluid to pass in a direction opposite to the normal flow direction once the device is cooled, from the external source to the outside via the purge line 14, the main discharge duct 5, the turbopump 3, the main admission duct 4, and the purge line 17.

Although the present invention is described with reference to specific implementations, it is clear that various modifications and changes may be performed on these implementations without going beyond the general ambit of the invention as defined by the claims. In addition, the individual characteristics of the various implementations mentioned may be combined in additional implementations. Consequently, the description and the drawings should be considered in a sense that is illustrative rather than restrictive.

1. A cooling method for cooling a device connected to a cryogenic tank via a main admission duct for feeding the device with cryogenic fluid once the device is cooled, wherein during cooling the cryogenic fluid is introduced into the device via a cooling admission duct that is different from the main admission duct and that presents a flow section that is narrower than the flow section of the main admission duct.

2. A cooling method according to claim 1, wherein said device is a pump.

3. A cooling method according to claim 2, wherein said device is a turbopump.

4. A cooling method according to claim 2, wherein said device is a propellant pump of a rocket engine.

5. A cooling method according to claim 1, wherein the cryogenic fluid introduced into the device via the cooling admission duct during cooling also comes from said cryogenic tank.

6. A cooling method according to claim 5, wherein, during cooling, the cryogenic fluid is pumped from the tank to said device via the cooling admission duct and returns from the device to the tank via said main admission duct in a direction opposite to the normal flow direction of the cryogenic fluid once the device is cooled.

7. A cooling method according to claim 5, wherein, during cooling, the main admission duct remains closed and the cryogenic fluid introduced into the device from the cryogenic tank is subsequently expelled via a purge line.

8. A cooling method according to claim 1, wherein the cryogenic fluid introduced into the device via the cooling admission duct comes from a source other than the cryogenic tank that feeds the device with cryogenic fluid via said main admission duct once the device is cooled.

9. . A cooling method according to claim 1, wherein the cooling admission duct is a main discharge duct once the device is cooled.

10. . A cooling method according to claim 9, wherein, during cooling, the cryogenic fluid is introduced into said main discharge duct via a purge line.
